(19) United States
(12) Patent Application Publication
(10) Pub. No.: US 2006/0102759 A1
(43) Pub. Date: May 18, 2006

(54) Automated tracking and billing system for the application of asphalt release agents

(76) Inventor: Mark DeLong, Fort Worth, TX (US)

Correspondence Address: GREENLEE WINNER AND SULLIVAN P C, 4875 PEARL EAST CIRCLE, SUITE 200, BOULDER, CO, 80301, US

(21) Appl. No.: 10/989,720

(22) Filed: Nov. 16, 2004

(51) Int. Cl. B05B 1/00

(52) U.S. Cl. 239/602

(57) ABSTRACT

This invention provides a system and method for tracking individual use of a fluid, in particular an asphalt release agent, applied to a vehicle. A sensor detects a vehicle having a vehicle identifier and sends this information to a processor. A spray unit sprays the vehicle with the fluid while a meter measures how much fluid is dispensed. The meter sends this information to the processor which links it with the vehicle identifier information. Billing and activity information is generated and can be shared to offsite computers through a network.

### STATEMENT REGARDING FEDERALLY SPONSORED RESEARCH OR DEVELOPMENT

Not Applicable.

### BACKGROUND OF THE INVENTION

Most roads, runways and parking lots are paved with hot mix asphalt (HMA), which is produced at an asphalt plant and transported to a construction site in trucks such as dump trucks, live-bottom trailers, hopper trailers, center drop trailers and double trailers. The drivers of the trucks transporting HMA may be employees of the company that is purchasing the HMA, or they may be contracted drivers who deliver the HMA to the purchasing company's worksite. A difficulty with transporting HMA is that asphalt sticks on contact to any surface. In the past and presently, drivers have either provided their own source of diesel to melt the asphalt out of the truck beds or in some instances, asphalt production plants that do not provide release agents are still providing diesel. In 1989, the Federal Department of Transportation banned the use of this procedure due to the detrimental effects the diesel had on the HMA. In 1990, Congress passed the Oil Pollution Act which prohibits the spilling, leaking, or dripping of oil, waste oil, or dredged spoil onto the ground or waterways. The spilling, leaking or dripping of diesel also falls under the restrictions of the Oil Pollution Act, The Clean Water Act, and is reportable under the Storm Water Runoff Program further making diesel unusable to remove asphalt from trucks. To prevent asphalt from sticking to the truck beds, materials known as asphalt release agents were developed to be applied to the truck bed prior to loading the HMA at the asphalt plant.

The producers of HMA were forced to start providing a release agent and a spray unit for drivers to spray their truck beds prior to loading the HMA. This step added extra cost to the producer in both product and time. Asphalt release agents are most commonly liquids, oils, or foams, creamed or otherwise, which can be applied to a truck bed or other surface by spraying through a spray rack, spraying with a wand or spray gun, or applied by sponging, rolling, wiping, painting, or dip-coating. Most of the release agents available today are delivered to the HMA producer in concentrate form. A venturi dilution system and water can be used with the release agent for propulsion to the spray system. There are few asphalt release agents available that are delivered to the HMA producer ready to use without requiring further dilution.

Current spray systems are inaccurate in their dilution and other than setting timers which can be activated more than once, sometimes inadvertently, there is no control as to how much release agent is applied or how to control the expense incurred by the drivers.

Current spray systems are inaccurate in their dilution and other than setting timers which can be activated more than once, sometimes inadvertently, there is no control as to how much release agent is applied or how to control the expense incurred by the drivers. In current automated systems (as described in “Contractor Driven to Improve Truck Movement,” Asphalt Contractor, April 1995, pp. 32 and 34 and another system described at www.digitalforces.com), a driver at an asphalt plant passes a sensor while approaching the loading area, which activates spray nozzles above the truck to apply the release agent. The truck is then positioned at the loading area where it receives the HMA load. The sensor is connected to a computer database at the plant operation house which keeps track of the vehicle information, including identification numbers, carrier name, destination, and tare weight of the truck. This information allows the operator to correctly load the vehicle with the proper HMA composition and amount. A record of the date and time spent loading the asphalt can also be kept.

Similarly, computer programs known in the art (such as described in U.S. Pat. No. 6,421,586) track construction materials delivered by transport trucks. These computer programs record the truck identification, the job each truck is assigned to, the destination site of the construction materials, and billing information for the materials. After the construction materials have been loaded onto the truck, tickets displaying the information can be generated for the driver, truck owner, or construction company. Computer programs and automated systems such as those described above are not currently used to monitor the application of release agents to vehicles during the delivery of HMA to construction sites.

Asphalt plants must either absorb the cost of the release agent sprayed onto the trucks or charge the company purchasing the HMA for the cost of the release agent by building it in the price of the HMA. Current automatic systems and manual spray systems do not keep track of the amount of release agent used on individual trucks. The cost charged to the companies purchasing the release agent can be estimated from the total cost of the release agent, as calculated per ton, for example, divided by the approximate number of trucks treated by the release agent. However, this method does not determine the amount of release agent actually used by an individual truck. Additionally, several different companies may send large numbers of trucks to pick up loads of HMA on any given day, and each truck may use a different amount and different mixture of release agent. Further complicating matters is the fact that drivers who transport HMA may not belong to the company purchasing the asphalt and may use more release agent than the purchasing company is willing to pay for, or more release agent than is necessary.

The asphalt plant may also have to bear the responsibility and cost of maintaining and repairing the spray system. Of particular interest is when the spray system breaks down or becomes damaged due to the negligence or misuse of a driver. For example, a driver may drive into the spray system. If a current system breaks down, the drivers must report the problem to the asphalt plant. Current release agent spray systems do not have features which alert the asphalt plant, or whatever entity is responsible for the operation of the spray system, when the spray system becomes inoperable other than a driver bringing a complaint. Current systems also have no way of identifying what truck or driver was using the spray system when it ceased operation or became damaged.

U.S. Pat. Nos. 6,341,271 and 5,983,198 disclose integrated systems for inventory management, delivery and billing. Sensors detect the current amount of a product at a location, such as at a manufacturing plant, and the recent rate of use. This information is communicated to a vendor's computer, which calculates when more product should be delivered to the location and price information. The vendor's computer may initiate delivery of more product to the location and automatically bills the location for the amount delivered.

Although U.S. Pat. Nos. 6,341,271 and 5,983,198 disclose systems by which a vendor can manage the inventory and of a product at a location, they do not provide a system that tracks the amount of product consumed at the location by individual end users. Additionally, neither of these two patents discloses an inventory system adapted for monitoring the application of an asphalt release agent to individual vehicles.

What is needed is a system and method of monitoring and recording the amount of a fluid, such as a release agent, applied to individual vehicles for billing purposes and to generate activity reports. Also needed is a method where a vendor provides a service to track the amount of release agent applied to individual vehicles while optionally monitoring the remaining inventory of the release agent at the asphalt plant and optionally supplying the release agent when needed as well as identifying systems that are no longer functioning.

### BRIEF SUMMARY OF THE INVENTION

This invention provides a novel system and method for tracking the application of a fluid, such as an asphalt release agent, to a vehicle. The present invention is appropriate for use with spray units that apply release agents at asphalt plants or other types of fluid application systems. The fluid can be any liquid, solution, suspension, oil, foam, or other substance able to flow freely, having no fixed shape and little resistance to outside stress. The present invention identifies a vehicle to be sprayed, determines the amount and type of fluid applied to the vehicle by the spray unit, and relays this information to a computer processor. This information, optionally with other information accessible to the computer processor, is used to generate activity, inventory, maintenance and billing reports.

In one embodiment, the present invention provides a method of tracking fluid applied to a vehicle comprising the steps: providing a spray unit able to apply a fluid to a vehicle; detecting a vehicle identifier associated with said vehicle and transmitting a corresponding vehicle information signal to a receiving processor; spraying said fluid from said spray unit onto said vehicle; providing a meter which determines the amount of fluid sprayed by said spray unit and transmitting/transceiving a corresponding meter output signal to said receiving processor; and generating activity information from the data carried by said vehicle information signal and meter output signal. In a further embodiment, the method also comprises generating billing information from the data carried by said vehicle information signal and meter output signal.

As a vehicle to be sprayed with the fluid approaches the spray unit, a sensor detects the vehicle identifier associated with the vehicle and transmits a vehicle information signal to the receiving processor. A “vehicle identifier associated with a vehicle” is any means known in the art that allows identification of a vehicle and includes, but is not limited to, bar codes, radio frequency transmitters/transceivers, password codes, magnetic identification cards, and optical identifiers. The vehicle identifier may be an object attached to the outside of the vehicle, such as a bar code; a portable object within the vehicle, such as a radio frequency transmitter/transceiver; or a password code or identification card kept by the vehicle operator specific for that vehicle.

The “vehicle information signal” is a signal which carries the identification data for the vehicle to the receiving processor. The vehicle identifier may convey other information about the vehicle in addition to the vehicle identification. This additional information is also part of the vehicle information signal and may provide information including, but not limited to, the driver of the vehicle, the owner of the vehicle, the type and amount of fluid needed by the vehicle, the destination of the vehicle, time spent being sprayed, and the job the vehicle is delivering to. In embodiments were the fluid is an asphalt release agent, the additional information may include the type of HMA to be loaded into the truck and the corresponding type and concentration of release agent to be used. Means for transmitting a signal carrying data, such as identification information of an object, are widely known in the art.

The sensor is any means known in the art that transmits an electronic signal in response to detecting a vehicle identifier. Such sensors include, but are not limited to, optical sensors, laser sensors, keypads, radio frequency transceiver, magnetic card swipe devices, and radio frequency receivers. The sensor is placed so that a vehicle having a vehicle identifier, such as a bar code or radio frequency transmitter/transceiver, passes through the detection field of the sensor while approaching the spray unit. In embodiments where the sensor is a keypad or magnetic identification card, the keypad or card reader is placed so that it is accessible to a vehicle operator while the vehicle approaches the spray unit. In some instances, the driver of the vehicle is determined by the plant operator who can manually enter the identity of the driver into the system.

The spray unit is any spray unit known in the art able to apply a fluid to a vehicle and includes both automatic spray systems and manual spray units, such as a wand or spray gun. A meter connected to the spray unit calculates the amount of fluid applied to the vehicle by measuring the actual volume or density of the fluid that flows through the spray unit during that time period, or by measuring the time the spray unit is activated and the estimated flow rate through the spray unit. The meter transmits a corresponding meter output signal to the receiving processor. The “corresponding meter output signal” or “meter output signal” is a signal which carries information on the amount of fluid applied by the spray unit.

Another embodiment of the present invention is a method of tracking asphalt release agent applied to a vehicle. This entails providing a vehicle identifier to a vehicle that is to be sprayed by a spray unit with an asphalt release agent; providing a sensor able to detect said vehicle identifier, wherein said sensor transmits a vehicle information signal to a receiving processor; providing a meter able to calculate the amount of release agent dispensed by said spray unit onto said vehicle, wherein said meter transmits calculated data to said receiving processor; and generating activity information from said vehicle information signal and said meter output signal. A further embodiment also comprises the steps: providing a spray unit able to dispense an asphalt release agent to a vehicle; and spraying said release agent from said spray unit onto said vehicle. The method further comprises generating billing information from the data carried by said vehicle information signal and meter output signal.

Preferably, the release agent spray unit is located at an asphalt production plant. The receiving processor is also preferably located at a control tower or building located at the asphalt production plant.

A fluid application tracking system of the present invention comprises a spray unit positioned so as to be able to apply a fluid to a vehicle; a vehicle identifier associated with said vehicle; a sensor positioned so as to be able to detect said vehicle identifier and able to transmit a vehicle information signal corresponding to said vehicle; a meter connected to said spray unit so as to be able to determine the amount of fluid dispensed by said spray unit and able to transmit a corresponding meter output signal; and a receiving processor connected to said sensor and said meter able to receive the vehicle information signal from said sensor and the meter output signal from said meter. The spray unit may be an automatic spray unit, or the spray unit may be manually operated.

For automatic spray units, the vehicle information signal and meter output signal may also be transmitted to a controller connected to the sensor and the spray unit. In one embodiment, the controller is a Programmable Logic Controller (PLC). The controller activates the spray unit when a vehicle is in position and stops the spray unit when application of the fluid to the vehicle is complete. Furthermore, the controller directs the automatic spray unit to apply the fluid to the vehicle according to parameters carried by the vehicle information signal, such as the dimensions of the truck where fluid is to be applied, how long to apply the fluid, and the amount and concentration of the fluid. A spray unit may be able to apply fluids, such as asphalt release agents, having different compositions, mixtures, or concentrations depending on the desired application. The controller also directs the spray unit to apply the correct fluid, mixture, or concentration when the spray unit has more than one fluid, mixture, or concentration available.

By “directing the spray unit” it is meant that the controller sends a signal to the spray unit carrying information on the application of fluid to the vehicle, wherein the spray unit is responsive to the signal from the controller. In one embodiment, the type of fluid and amount of fluid to be applied by the spray unit is calculated by the controller using the information carried by the vehicle information signal, and the controller stops the spray unit when the meter output signal indicates that proper amount of fluid has been applied. In another embodiment, the type of fluid and amount of fluid to be applied by the spray unit is calculated by the receiving processor or another separate processor, which transmits a signal to the controller causing the controller to direct the operation of the spray unit.

As used herein, the term “connected to” means one component of the present invention is in electronic, optical, ultrasonic, wireless ethernet or other signal-receiving connection with another component.

The receiving processor refers to a computer processor, such as a central processing unit, which is connected to the sensor and meter and receives the data carried by the vehicle information signal from the sensor, and the meter output signal from the meter. Inventory computer programs, as known in the art, can use data carried by the vehicle information signal and the meter output signal, herein also referred to as “vehicle information” and “meter output information,” received by the processor to associate the signals with each other and use them to generate activity information and billing information, which are displayed as activity reports and billing reports. The receiving processor either is part of the computer system having the inventory computer programs, or electronically transmits the data carried by the vehicle information signal and the meter output signal to a computer system having the inventory computer programs. Alternatively, the data can be manually entered into the computer system by an operator. The computer system having the inventory computer programs, which generate the activity information and billing information, will output (display) the activity information and billing information in either paper printout form or on a screen, so that the data can be transferred, manually or automatically, to the asphalt plant billing system.

The activity information contains the spray unit activity for each vehicle and includes, but is not limited to, the date, time spent applying the fluid to the vehicle, the driver of the vehicle, the owner of the vehicle, the type of HMA, the type of release agent, the amount of fluid used, and identification of the job the vehicle is assigned to. The billing information contains the total billing price of the fluid dispensed by the spray unit for each vehicle and is calculated from the amount of fluid applied by the spray unit to the vehicle and the optional pricing of the fluids. The billing information can also be used to create billing invoices, which are statements requesting payment. Billing invoices can be given to the driver after the vehicle leaves the spray unit, or sent to the entity responsible for paying the costs incurred by the vehicle.

### BRIEF DESCRIPTION OF THE DRAWINGS

FIG. 1 is schematic primarily block diagram of a fluid application tracking and billing system of the present invention.

### DETAILED DESCRIPTION OF THE INVENTION

The invention may be further understood by the following non-limiting examples.

All references cited herein are hereby incorporated by reference to the extent not inconsistent with the disclosure herewith.

Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given.

In one embodiment of the present invention, where the spray unit is used to apply a release agent at an asphalt plant, the activity information and billing information are integrated with information generated at different parts of the asphalt plant. The vehicle information and meter output information can be shared with other systems at the asphalt plant. Likewise, information from other systems can be incorporated into the activity reports and billing reports. Thus, the system of the present invention allows an asphalt plant to provide a company purchasing HMA a complete activity report, billing report, or billing invoice on all activity and expenses incurred at the plant by a vehicle including time spent at the plant, the type and amount of HMA loaded, and the type and amount of release agent used.

In one embodiment of the present invention, the receiving processor is part of an onsite computer, i.e. a computer located at the same site as the spray unit. A computer program stored on the hard drive of the onsite computer stores a database and computer programs, as known in the art, used to generate and display the billing information and activity information. In one embodiment, the activity reports and billing reports are generated at the same site as the spray unit. In a further embodiment, billing invoices are generated at a different site than the site having the spray unit.

The onsite computer comprises an electronic storage device able to store the vehicle and meter output information. Saved vehicle and meter output information from multiple applications by the spray unit can be compared and used to track how much fluid was used for any given application(s), how often fluid was used on a particular vehicle, and total time spent spraying vehicles.

In one embodiment of the present invention, the vehicle identifier is a bar code located on the vehicle that is read by a laser sensor as the vehicle approaches the spray unit. In another embodiment, the system utilizes radio frequency identification (RFID) where the vehicle identifier is a radio frequency transmitter/transceiver and the sensor is a radio frequency receiver/transceiver. Bar codes and RFID devices allow large amounts of additional vehicle information to be delivered to the receiving processor.

Alternatively, the vehicle identifier and sensor comprise a password code unique for that vehicle which is entered into a keypad, which then transmits a vehicle information signal to the receiving processor.

As another alternative, the vehicle identifier and sensor comprise an identification card having a magnetic strip uniquely coded for that vehicle and a card swipe device. The card swipe device reads the magnetic strip as the identification card is inserted or passed through the device, which causes the card swipe device to transmit a vehicle information signal to the receiving processor.

In one embodiment of the present invention, the receiving processor is in communication with a network, such as the internet, and shares the vehicle information and meter output information to offsite computers connected to the network. “In communication with a network” means that one processor or computer connected to the network can send/receive signals carrying data through the network to another processor or computer connected to the network. The signal is transmitted to the network through means including, but not limited to, a modem or wireless communications. Access to the vehicle and meter output information is restricted to offsite computers authorized to receive the information.

In one embodiment of the present invention, an offsite computer operated by the vendor of the fluid applied to the vehicles is authorized to receive the vehicle and meter output information. In one embodiment, the activity reports and billing information are generated by a program stored on the vendor computer. The vendor can also use the vehicle and meter output information to monitor the levels of fluid remaining at the spray unit location and optimize re-supplying the spray units when necessary.

In one embodiment of the present invention, a system vendor may provide, for a fee, an asphalt plant with a system that tracks the amount of release agent applied by the spray unit to individual vehicles. A separate vendor may supply the release agent to the asphalt plant. In a further embodiment, the system vendor will, for a fee or pursuant to a license, monitor the inventory of the release agent and transmit this information to the release agent vendor, or allow the release agent vendor to have access to the information generated by the tracking system so that the release agent vendor can monitor the inventory. The tracking service provided to the asphalt plant can be operated independently of the inventory monitoring system provided to the release agent vendor. In another embodiment, the system vendor will provide the asphalt plant with the tracking system as well as the release agent. In fact, it would be beneficial in terms of efficiency and cost for the same vendor to supply the tracking system, supply the release agent, and monitor the inventory of release agent at the spray unit to know when to re-supply the spray unit.

A system vendor that offers a system of this invention to an asphalt plant to track the application of release agents may provide the system for a set period of time. For example, the system vendor may provide the system for a period of three months or a longer. The system vendor may include a system control which prevents the tracking system from being used after the time period has elapsed unless the asphalt plant pays to renew the service. Similarly, if a separate vendor supplies the asphalt plant with release agent and the system vendor provides a system which tracks the inventory of the release agent, then the system vendor may include a system control which ends the inventory tracking service unless the separate vendor pays to renew to service.

The present invention also includes diagnostic sensors connected to the spray unit to monitor components of the spray unit and transmit a diagnostic signal when the spray unit becomes damaged or inoperable. By monitoring the components, it is meant that the diagnostic sensors transmit a diagnostic signal if they detect that a component of the spray unit is non-functional. The diagnostic signal is sent to whatever entity is responsible for the maintenance of the spray unit. In one embodiment, the diagnostic signal is sent to an alarm in the control tower or building at the asphalt plant.

Where the vendor supplying the fluid maintains the spray unit, diagnostic sensors connected to the spray unit monitor the spray unit and transmit a diagnostic signal to the vendor computer. The diagnostic signal indicates the status of the spray unit, i.e. if the spray unit is in working condition. The vendor computer alerts the fluid vendor when the diagnostic sensors indicate the spray unit is damaged or inoperable. The system can also record which driver or vehicle was using the spray unit when the damage occurred.

In one embodiment of the present invention, an electronic account is assigned to each vehicle having a vehicle identifier. An electronic account is a data set unique for each vehicle stored on a computer. In one embodiment where the present invention is used for the application of an asphalt release agent, the account is stored on an onsite computer at the asphalt plant. Information on the vehicle is input into the account. This account information may include information that is alternatively provided by the vehicle information signal from the sensor, such as which construction job the truck is delivering to, the type of release agent to be used on this truck, the type and amount of asphalt to be loaded onto the truck, and the name and address of the entity that is to be billed for the asphalt and asphalt release agent. The same account is used each time the same vehicle visits the asphalt plant. Information in the account is changed and updated as needed. The account is associated with the vehicle identifier so that when a receiving processor receives a vehicle information signal and meter output signal, the data carried by the vehicle information signal and meter output signal is linked with the corresponding account information.

In one embodiment of the present invention, the fluid application tracking system is used to monitor and record the application of asphalt release agent to trucks. The system utilizes an automatic spray unit located at an asphalt plant, where it is integrated with the asphalt loading process. The vendor providing the tracking system to the asphalt plant also provides the release agent to the asphalt plant and uses the information from the receiving processor to determine when to re-supply the spray unit.

In this embodiment, a RFID system is used where the vehicle identifier is a radio frequency transmitter/transceiver and the sensor is a radio frequency receiver/transceiver. Radio frequency transmitters/transceivers are advantageous because they do not require any part of the driver to leave the truck. Some vehicle information, such the type and amount of release agent needed to apply to the truck, can be stored on the radio frequency transmitter/receiver. When the radio frequency receiver/transceiver detects the radio frequency transmitter/transceiver, this information is received along with the identification of the truck and is transmitted to the PLC, which directs the spray unit to deliver the appropriate type and amount of release agent.

The receiving processor is part of the onsite computer at the asphalt plant and receives the vehicle information signal from the radio frequency receiver/transceiver. A meter connected to the spray unit measures the amount of release agent applied to the truck and transmits the corresponding meter output signal to the onsite computer. The onsite computer stores this vehicle and meter output information in the account associated with the vehicle identifier. Billing information and activity information are generated from the vehicle information, meter output information, and account information. The activity information and billing information are displayed as activity reports and billing reports.

The information on the quantity of hot mix asphalt loaded onto the truck is optionally transmitted to the onsite computer, which stores it in the vehicle's account. This information can be used to automatically calculate individual and running cost per production ton for release agent.

The receiving processor transmits the vehicle information and meter output information through a network to the vendor offsite computer. The vendor offsite computer may use the vehicle and meter output information to monitor the levels of release agent remaining at the spray unit location and optimize re-supplying of the spray units when necessary.

In this embodiment, the receiving processor optionally transmits the activity information and billing information to an offsite computer controlled by the same entity running the asphalt plant, which generates a billing invoice for the truck.

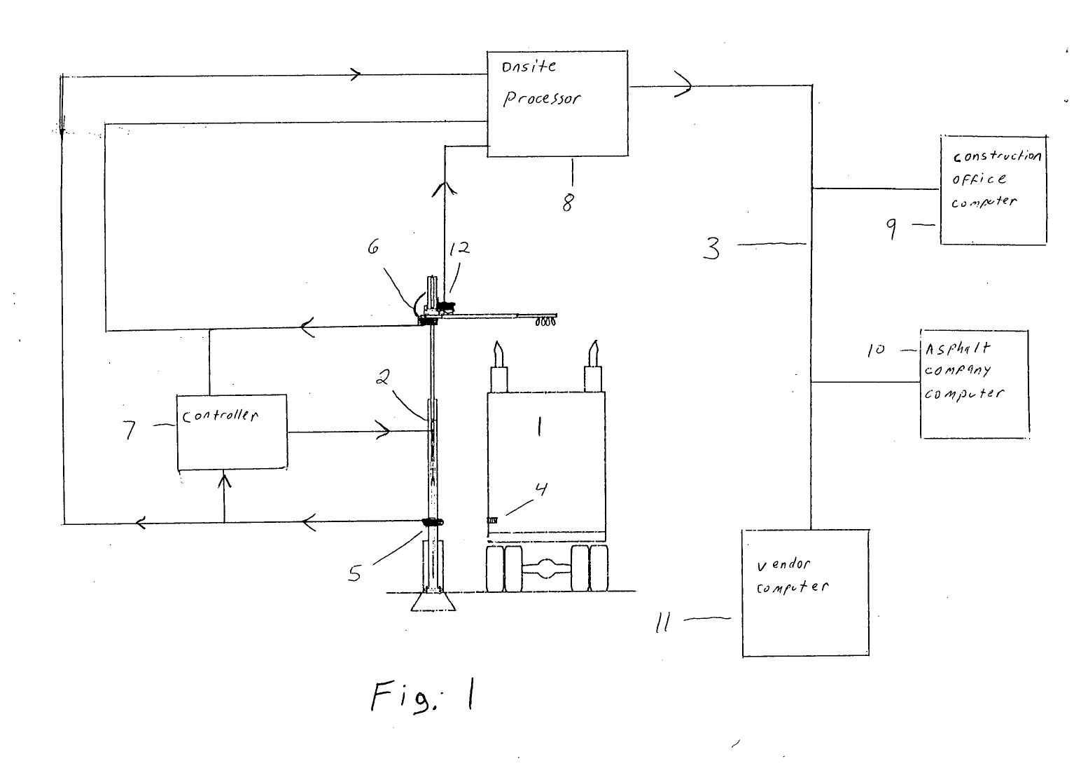

FIG. 1 shows a fluid application tracking system of the present invention. A vehicle 1 used to deliver construction materials to a construction site is positioned under the spray unit 2. A bar code 4 (the vehicle identifier) is disposed on the side of the vehicle 1. A laser sensor 5 is positioned on the spray unit 2 so that the bar code 4 will pass through the detection field of the laser sensor 5 as the vehicle 1 approaches. When laser sensor 5 detects bar code 4 a vehicle information signal is sent to controller 7.

Controller 7 causes spray unit 2 to begin dispensing a fluid to the vehicle 1. Meter 6 measures the amount of fluid dispensed by the spray unit 2 and transmits a meter output signal to the controller 7. Controller 7 shuts down the spray unit 2 after a predetermined amount of time expires, or when the output signal from the meter 6 indicates the proper amount of fluid has been applied.

The laser sensor 5 and meter 6 also transmit the vehicle information signal and meter output signal to an onsite receiving processor 8. Receiving processor 8 is in communication with a network 3. Electronic signals conveying the vehicle and meter output information are transmitted from the receiving processor 8 through the network 3 to a plurality of offsite computers, including a construction office computer 9, an asphalt company computer 10, and vendor computer 11. The construction office 9 computer is operated by the company purchasing the HMA and release agent. The asphalt company computer 10 is operated by the company operating the asphalt plant and may be used as a back-up location to store the vehicle and meter output information, or as an alternative location to generate the billing reports, activity reports, or billing invoices. Billing information and activity reports can also be stored or generated at construction office computer 9 and vendor computer 11. Thus, personnel in charge of the construction job can monitor the status of the vehicle 1 and verify costs incurred at the spray unit 2.

In an embodiment where the vendor of the fluid also supplies the spray unit 2, diagnostic sensor 12 connected to spray unit 2 monitors the working status of spray unit 2. Diagnostic sensor 12 transmits a diagnostic signal to receiving processor 8 when a component of the spray unit 2 is non-functional. The diagnostic signal is then transmitted to vendor computer 11. The diagnostic signal notifies vendor computer 11 when spray unit 2 is damaged or inoperable.

While the invention has been described with certain preferred embodiments, it is understood that the preceding description is not intended to limit the scope of the invention. It will be appreciated by one skilled in the art that various equivalents and modifications can be made to the invention shown in the specific embodiments without departing from the spirit and scope of the invention. All publications referred to herein are incorporated herein to the extent not inconsistent herewith.

We claim:

1. A fluid application tracking system comprising:
a spray unit positioned so as to be able to apply a fluid to a vehicle;
a vehicle identifier associated with said vehicle;
a sensor positioned so as to be able to detect said vehicle identifier and able to transmit a vehicle information signal corresponding to said vehicle;
a meter connected to said spray unit so as to be able to determine the amount of fluid dispensed by said spray unit and able to transmit a corresponding meter output signal; and
a receiving processor connected to said sensor and said meter able to receive and associate the vehicle information signal from said sensor and the meter output signal from said meter.

2. The system of claim 1 wherein said spray unit is an automatic spray unit.

3. The system of claim 2 further comprising a controller connected to said sensor so as to receive said vehicle information, wherein said controller directs the operation of said spray unit.

4. The system of claim 1 wherein said spray unit comprises an asphalt release agent.

5. The system of claim 1 comprising a computer program stored on a computer comprising said receiving processor, wherein said computer program is programmed to create and display billing information based on the vehicle information and meter output information.

6. The system of claim 5 wherein said computer program generates a billing invoice from said billing information.

7. The system of claim 1 comprising a computer program stored on a computer comprising said receiving processor, wherein said computer program is programmed to create and display activity information based on the vehicle information and meter output information.

8. The system of claim 1 wherein said receiving processor is part of an onsite computer.

9. The system of claim 8 further comprising an account maintained on said onsite computer containing account information on said vehicle.

10. The system of claim 8 comprising an electronic storage device for electronically storing the data carried by the vehicle information signal and meter output signal.

11. The system of claim 1 further comprising a network in communication with said receiving processor.

12. The system of claim 11 comprising an offsite computer in communication with said network.

13. The system of claim 12 wherein said offsite computer is operated by the vendor supplying the fluid.

14. The system of claim 13 wherein said offsite computer monitors the level of fluid remaining at said spray unit and displays a notice when the spray unit should be re-supplied with said fluid.

15. The system of claim 13 further comprising one or more diagnostic sensors connected to said spray unit, said diagnostic sensor able to monitor components of said spray unit and transmit a diagnostic signal to said offsite computer, wherein said offsite computer displays the status of said spray unit.

16. The system of claim 1 wherein said vehicle identifier is selected from the group consisting of a bar code, a radio frequency transmitter, a password code, and a magnetic identification card.

17. The system of claim 1 wherein said sensor is selected from the group consisting of an optical sensor, an ultrasonic sensor, a laser sensor, a radio frequency receiver, a keypad, and a card swipe device.

18. A method of tracking fluid applied to a vehicle comprising the steps:
providing a spray unit able to apply a fluid to a vehicle;
detecting a vehicle identifier associated with said vehicle and transmitting a corresponding vehicle information signal to a receiving processor;
spraying said fluid from said spray unit onto said vehicle;
providing a meter which determines the amount of fluid sprayed by said spray unit and transmitting a corresponding meter output signal to said receiving processor; and
generating activity information from the data carried by said vehicle information signal and meter output signal.

19. The method of claim 18 further comprising the step: generating billing information from the data carried by the vehicle information signal and meter output signal.

20. The method of claim 18 wherein said receiving processor is part of an onsite computer.

21. The method of claim 18 further comprising the step: transmitting the vehicle information signal and meter output signal to a plurality of offsite computers in communication with a network comprising said receiving processor.

22. The method of claim 21 wherein one of said plurality of offsite computers is operated by a vendor supplying the fluid.

23. The method of claim 18 further comprising the step: assigning an electronic account to a vehicle having a vehicle identifier and inputting information on said vehicle into said account.

24. The method of claim 23 wherein said activity information contains data from the information input into said account.

26. The method of claim 18 wherein said fluid is an asphalt release agent.

27. The method of claim 18 further comprising the steps:
delivering to said vehicle a load of asphalt; and
generating an activity or billing report containing information on said asphalt delivered to said vehicle.

28. A method of tracking asphalt release agent applied to a vehicle comprising the steps:
providing a vehicle identifier to a vehicle that is to be sprayed by a spray unit with asphalt release agent;
providing a sensor able to detect said vehicle identifier, wherein said sensor transmits a vehicle information signal to a receiving processor;
providing a meter able to calculate the amount of said release agent dispensed by said spray unit, wherein said meter transmits a meter output signal to said receiving processor; and
generating activity information from said vehicle information signal and said meter output signal.

29. The method of claim 28 further comprising the steps: providing a spray unit able to dispense an asphalt release agent to a vehicle, and spraying said release agent from said spray unit onto said vehicle.

30. The method of claim 29 further comprising providing asphalt release agent to said spray unit.

31. The method of claim 30 further comprising the step: generating billing information from said vehicle information signal and said meter output signal.

32. The method of claim 28 further comprising transmitting said vehicle information signal and said meter output signal from said processor through a network to an offsite computer.

33. The method of claim 32 further comprising generating activity information or billing information from said vehicle information signal and said meter output signal at said offsite computer.

34. The method of claim 32 further comprising monitoring the level of release agent remaining at said spray unit and notifying a vendor supplier when the spray unit should be re-supplied with said release agent.

35. A method of tracking asphalt release agent applied to a vehicle comprising the step: providing to an asphalt plant a fluid application tracking system of claim 1 suitable for applying asphalt release agent to vehicles.

36. The method of claim 35 further comprising the steps: monitoring the amount of release agent dispensed by said fluid application tracking system; and notifying the release agent supplier when it is time to re-supply the system with release agent.

37. The method of claim 35 further comprising the step: providing asphalt release agent for said fluid application tracking system.
